(19) United States
(12) Patent Application Publication
(10) Pub. No.: US 2013/0179592 A1
(43) Pub. Date: Jul. 11, 2013

(54) NETWORK APPARATUS WITH FUNCITON OF ACCESS PATH SELECTION AND METHOD FOR SELECTING ACCESS PATH THEREOF

(71) Applicant: CARRY TECHNOLOGY CO., LTD., NEW TAIPEI CITY (TW)

(72) Inventors: Lin Tien, Taipei City (TW); Ying-Ching Lee, New Taipei City (TW); King-Foo Wong, Taipei City (TW); Ching-Yun Ou Yang, New Taipei City (TW)

(73) Assignee: CARRY TECHNOLOGY CO., LTD., NEW TAIPEI CITY (TW)

(21) Appl. No.: 13/682,716

(22) Filed: Nov. 20, 2012

(30) Foreign Application Priority Data
Jan. 9, 2012 (TW) 101200491

(51) Int. Cl. G06F 15/173

(52) U.S. Cl. CPC G06F 15/17312
USPC 709/238

(57) ABSTRACT

Disclosed herein is a network apparatus with function of access path selection. An electronic device is allowed to access the external memory connected to the network apparatus. The apparatus includes access interfaces for a memory card and at least one external device. The network apparatus is such as a wireless routing device. In one embodiment of the invention, the network apparatus simultaneously supports two or more interfaces connected to external storage medium. The interfaces may include a slot for plugging a memory card, and a standard interface for connecting one external storage device. After resolving file system of the medium, the terminal device is allowed to remotely access the external storage medium by wired or wireless connection. The network apparatus successfully renders functions of accessing the network-attached storage and card reader. Smart energy conservation and hot swapping are also reached in the apparatus through power management mechanism.

### BACKGROUND

1. Technical Field

The present invention is related to a network apparatus with function of access path selection and a method of selection thereof, in particular, to a network routing device having a memory access interface and allowing access path selection.

2. Description of Related Art

The card readers wildly distributed over markets are usually the appliances equipped with wired universal serial bus (USB). The card reader is provided for a host to access the data in a memory card which is plugged into the reader, but incapable of sharing with other hosts.

However, some current technologies may allow multiple computer systems to access the data in a memory card over network by means of network sharing. For example, a kind of network disk is configured to conduct the network sharing mechanism over an internal network.

More, a router is usually required for the regular computer host to get on the network. A router with a card reader has been developed in the prior technology. The computer host is allowed to access the memory card plugged to the router's reader when the computer host is connected to this router.

### SUMMARY

Provision in the network apparatus with function of access path selection is for users to access and share the data in a memory card or regular network storage over a network. The network apparatus in accordance with the present invention integrates types of interfaces for the various storage medium. A circuit for automatically selecting access path is particularly disclosed for rendering the network apparatus to access the various storage medium conveniently.

In one of the embodiments of the invention, the circuitry in the network apparatus with function of access path selection includes a network communication circuit for performing network packets routing, a wireless communication circuit for conducting wireless transmittance, an independent power management circuit, an interface for external device, and a circuit for selecting access path.

The control unit is a control circuit for controlling internal circuit units of the network apparatus. The network apparatus also provides network connection service for the external terminal devices by its wireless communication module and antenna. The apparatus includes wire communication module for forwarding data packets generated by the wireless terminal device to a wire network.

The described network apparatus provides at least two connecting ports for external connection. One of the connecting ports is to be an interface of a memory card through a memory card access unit. The other port is for connecting to an external storage device through an external access unit.

The network apparatus includes an access path selecting unit for electrically connected to the memory card access unit and the external access unit. This access path selection unit is used to arbitrate the access path for a terminal device to access the memory card or the external storage device connected to the network apparatus.

In an exemplary example, the access path selection unit may firstly determine if any memory card is connected to the apparatus according to an electrical signal generated from the memory card access unit or the external access unit. In the meantime, while the memory card is connected to the network apparatus, the access signal generated by the control unit may be forwarded to the memory card access unit for the terminal device to access the memory card.

On the other hand, the access path selection unit may also determine if any external storage device is connected to the network apparatus through the external access unit according to the related electrical signal. If the memory card may not be connected, but the external storage device does, the access path is configured to establish the connection to the external storage device made by the control unit through the access path selection unit and the external access unit.

According to one embodiment, the control unit of the network apparatus is electrically connected to the power management unit. The power management unit allocates the power supplied to the internal components of the apparatus. In particular, the power management unit is configured to allocate the power under a requirement of low power consumption based on the status of external connections.

The access path selection unit includes a signal detection unit which is electrically connected to the memory card access unit and the external access unit. Since the connection usually carries the electrical signals related to the interfaces, the signal detection unit may detect the electrical signal specified to the pins. The electrical signal may be referred to conduct the determination of any device is connected. The control unit is configured to make a selection of the access path in addition to determine the connection through the access path selection unit.

According to the disclosure, the network apparatus may maintain minimum power consumption for the memory card access unit for the basic workload while there is no any memory card is plugged to the apparatus. When a memory card is plugged, the signal detection unit may receive a plugging signal from the memory card access unit. The control unit controls the power management unit to supply power to the memory card access unit 411. Otherwise, if there is no memory card plugged, the signal detection unit may determine if an external device is connected according to the electrical signal of the pin of the external access unit. When any connection made by the external device is confirmed, the control unit is configured to control the power management unit to supply power to the external access unit. Or, the minimum power will be supplied for the purpose of energy reservation.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a schematic diagram of a network configuration for the network apparatus with function of access path selection in accordance with the present invention;

FIG. 2 is a schematic diagram illustrating the configuration of connections for the network apparatus of one embodiment of the present invention;

FIG. 3 is a schematic diagram of circuit blocks illustrating the network apparatus in accordance with the present invention;

FIG. 4 schematically shows an embodiment of mechanism of access path selection of the network apparatus in accordance with the present invention;

FIG. 5A shows another embodiment illustrating the mechanism of access path selection of the network apparatus in accordance with the present invention;

FIG. 5B shows an embodiment of the circuitry of the network apparatus of the present invention;

FIG. 6A shows one of the embodiments of the network apparatus connected with a power source in accordance with the present invention;

FIG. 6B shows another embodiment of the network apparatus connected with the power source in accordance with the present invention;

FIG. 7 shows a flow chart illustrating the method of access path selection for an external memory of the network apparatus in accordance with the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

According to one of the embodiments of the network apparatus with function of access path selection in accordance with the present invention, the network apparatus is an integration of a wireless network device, an independent power supply, a card reader, and an interface for connecting with an external storage. The network apparatus may be, but not limited to, a network router, a gateway or any target device. If the network apparatus is applicable to be the network router, it is provided for some portable devices that do not have any external interface to access an external storage medium via this network apparatus. The external storage medium may be a memory card, an external hard disk, or an optical disk drive.

In the disclosure of the network apparatus in accordance with the present invention access path selection, the network apparatus includes at least two kinds of interfaces for accessing the external storage medium. The apparatus also provides a service of remote data storage by its own network communication. Thus the network apparatus may simultaneously serves multiple terminal devices to access the network or the storage. The terminal device is such as a personal computer, tablet computer, smart phone, or any electronic device capable of connecting network. The apparatus may be a portable, independent, and network-enabled device.

In one exemplary example, the network apparatus at least includes a memory card access interface, such as a card reader, which supports functions of energy reservation and hot swapping. The network apparatus may also include one more access interface for connecting with an external storage device. The access interface is such as a universal serial bus (USB), a peripheral component interconnect (PCI, e.g. PCI Express), Firewire, or Thunderbolt. The network apparatus has an independent power supply that may be direct current power (DC) or alternating current power (AC). The network apparatus allows the terminal device which is connected thereto to select one of the services via a specific communication protocol.

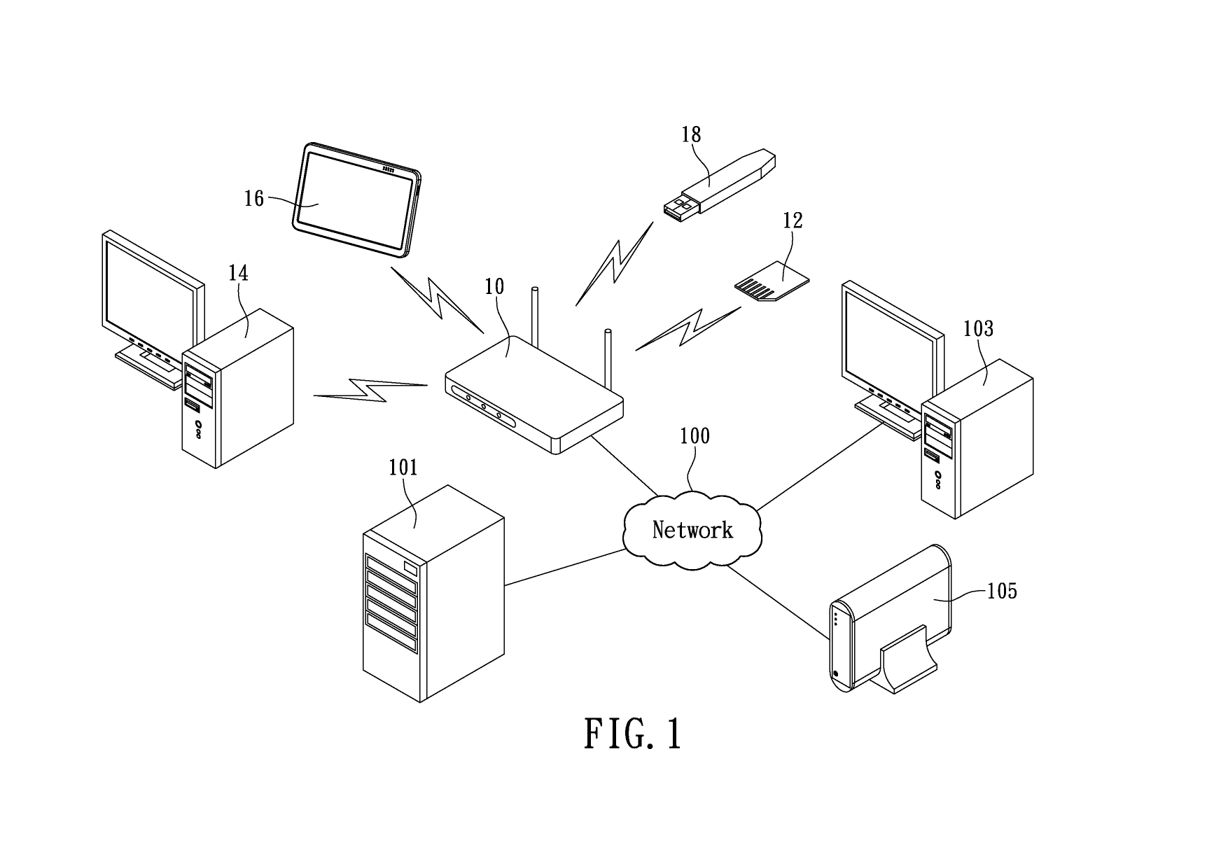

According to one embodiment described in FIG. 1, it is disclosed that a network apparatus is configured to establish a network while it provides various devices to access its services.

The shown network apparatus 10, such as a routing device, may simultaneously receive multiple connections from many terminal devices. The terminal device is such as a computer 14 or an electronic device with function of network communication. The network apparatus 10 is exemplarily used to forward the data packets generated by the terminal device to another target over network 100. The terminal device, by the network communication, may connect with a server 101 over the network 100. The terminal device is therefore able to access the resource in the server 101. The terminal device is also able to link with another computer 103 or access the network storage 105 which is connected to the network 100 directly.

The network apparatus in this disclosure is particularly equipped with a slot for plugging memory card 12, or any kind of reader mechanism. Further, the apparatus also includes a flask disk 18 or an external storage medium. Inside the network apparatus, a standard bus may be adopted to connect with the memory card 12, flask disk 18, or any other external storage medium. Those external pluggable mechanisms allow terminal device to access the memory card 12 or any storage conveniently. The mentioned standard bus is such as USB, I2C, or UART (Universal Asynchronous Receiver/Transmitter). However, both serial type and parallel types of data transmission are able to conduct the intercommunication for each interface.

In an exemplary example, the communication protocol supported by the network apparatus 10 is made to provide a HTTP (hypertext transmission protocol) file server, or a FTP (file transfer protocol) file server. The HTTP file server is used to provide a service of file transmission for the memory of any host. The FTP file server is to be a service for accessing the data in file folder. In general, for cross-platform application, the file system thereof may be FAT, FAT32, NTFS, or exFAT. In practice, the file system may not be limited to the listed file systems but may be altered by platform.

By which, the terminal device (e.g. 14, 16) may connect with the network apparatus 10 by the apparatus-supported communication protocols. The terminal device may further access the data of external storage medium through the standard bus inside the apparatus. Furthermore, it is not limited that the network apparatus 10 may has a built-in storage which is accessible to the terminal device by the same communication technology.

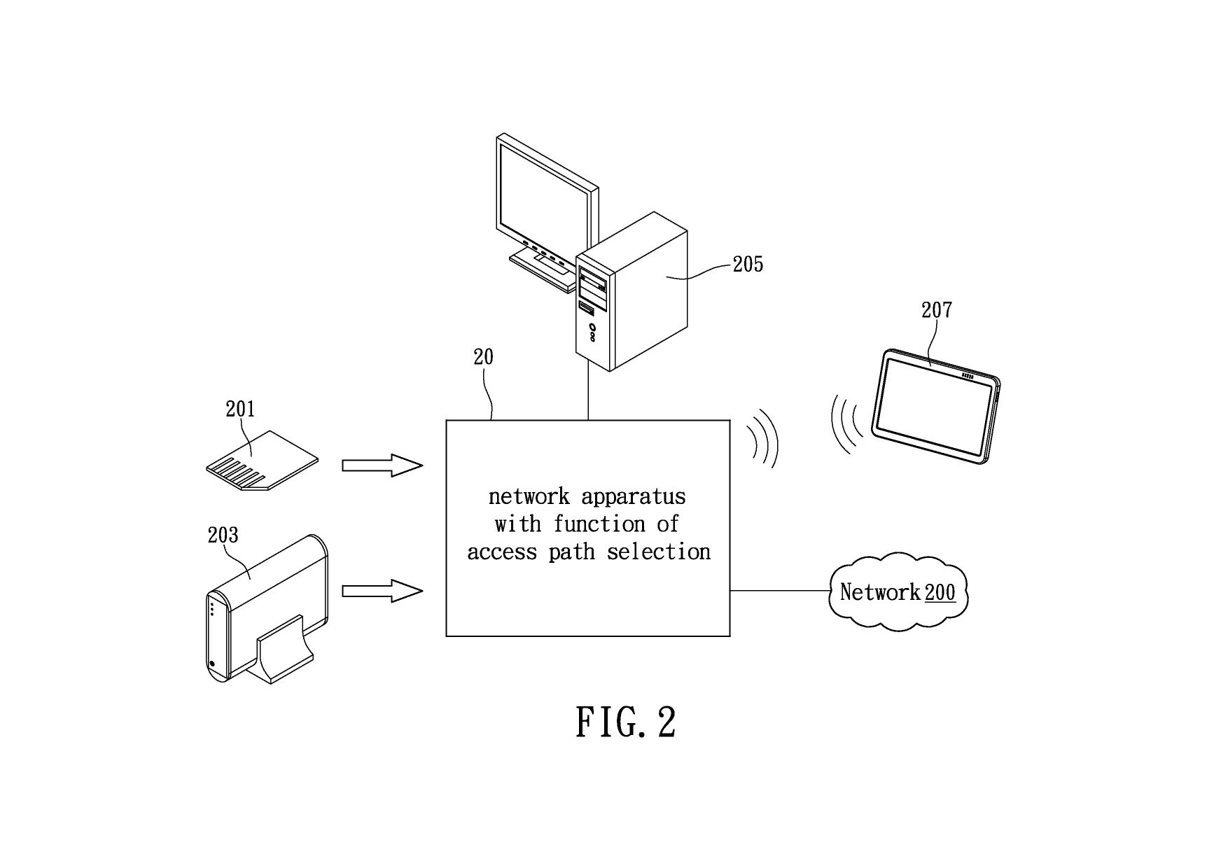

The exemplary embodiment show in FIG. 2 describes the peripherals connected with the network apparatus in accordance with the present invention.

The connection described in FIG. 2 is related to a network apparatus 20 connected with an external device. The network apparatus 20 is operated as a network router. The apparatus 20 provides routing service for the terminal device, such as near-end mobile electronic device 207 or a personal computer system (not shown), to link with network 200. The electronic device 207 is exemplarily the poor memory-expandable electronic device such as a tablet computer or smart phone. The network apparatus 20 in accordance with the present invention accordingly provides more expandable capacity of memory. In the current example, the network apparatus 20 provides a reader interface for a memory card 201. An access interface for an external storage device 203 may be included in the apparatus. For example, a USB slot may be included for connecting with an external hard disk, a disk raid, or a flask disk. The network apparatus may also connect with a Network-Attached Storage (NAS) for each terminal device to access any type of the external storage medium.

The network apparatus 20 may exemplarily be equipped with a wire connecting port for connecting a near-end computer system 205. The network apparatus 20 may thereby provide network-connection service for the computer system 205 directly. The computer system 205 may be a power source supplied to the network apparatus 20 via this connecting port, or alternatively to charge the inside battery. In which, the connecting port may be a Type-B USB which is to be a charging receptacle.

In an exemplary example, the interface of the network apparatus 20 for connecting with the electronic device 207 may be implemented by a WiFi™ interface. The electronic device 207 may link network through this network apparatus 20. However, the network apparatus 20 may not only be limited to the WiFi interface but also the wire network port such as RJ-45 which is generally used for the computer system. The connection between the apparatus 20 and the computer system 205 is exemplarily made by USB port. Further, a card reader mechanism embodies the slot for plugging the memory card 201. The type of the reader mechanism may be specified to support the memory card 201. A combo-type slot may be adopted to be in compliance with various types of memory cards. More, the access interface of the apparatus 20 to the external storage device 203 is preferably, but not limited to, made by USB. The possible interface is such Firewire, Thunderbolt, PCI Express or UART.

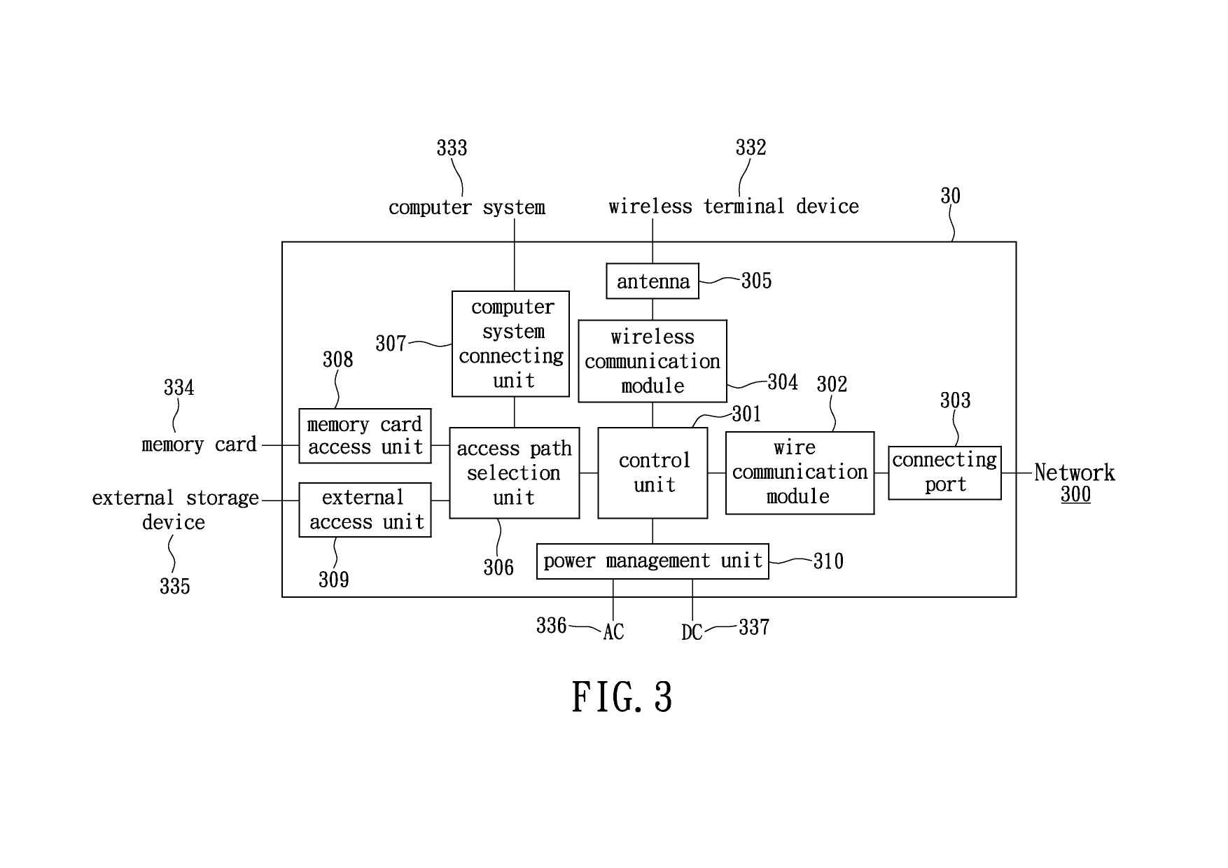

Reference is made to FIG. 3 describing circuit block of the network apparatus with function of access path selection in one embodiment of the present invention. The major circuits of the network apparatus 30 include a network communication circuit for performing network packets routing, a wireless communication circuit for conducting wireless communication, an independent power management circuit, an interface for connecting an external device, and a circuit provided for selecting access path.

The shown control unit 301 is a controller for governing the signals among inner circuit units of the network apparatus 30. The controller allows the connected terminal device to access its inner resources as required. Some other functions such as forwarding access path and activating/deactivating the access interface are also provided.

The wireless communication module 304 in the network apparatus 30 serves an external communication via an antenna 305. This wireless communication module 304 conducts the radio frequency (RF) signals. The network apparatus thereby provides wireless connection for the wireless terminal device 332.

The wire communication module 302 in the apparatus 30 is preferably for connecting network 300. The network apparatus 30 according to a routing scheme forwards the data packets from the wireless terminal device 332 to the wire network 300. The apparatus 30 performs packets accessing and forwarding. RJ-45 is one of the solutions for implementing the connecting port 303 of the network apparatus 30 for linking with the network 300.

Further, the wireless terminal device 332 is wirelessly connected with the network apparatus 30. The terminal device may also connect with the apparatus 30 in a wired manner. The network apparatus 30 accordingly provides services of forwarding packets to another network segment and accessing data in storage medium connected to the apparatus 30.

In FIG. 3, the network apparatus 30 includes at least two types of external connecting ports, in which a memory card access unit 308 serves an interface to a memory card 334 and an external access unit 309 is for connecting an external storage device 335. The memory card access unit 308 is a circuit for governing data access of the memory card 334. The circuit, including memory card 334, may determine the type of the connected memory card 334 by detecting the electronic signals of the interface. The detection may also include reading the information such as capacity or file format.

An access path selection unit 306, which is electrically connected with the memory card access unit 308 and the external access unit 309, is particularly included in the apparatus 30. This access path selection unit 306 is also electrically connected to the control unit 30 of the apparatus 30. The access path selection unit 306 is used to be an arbiter for determining the access path to the memory card 334 or to the external storage device 335. This access path is determined for the external terminal device (332 or the like) to access the storage.

For example, while the memory card 334 is connected with this network apparatus 30 via the memory card access unit 308, the access path selection unit 306 may then find out the memory card 334 is plugged by retrieving its electrical signal. In the meantime, the terminal device may successfully access the memory card 334 since the control unit 301 directs the access signals to the memory card access unit 308.

On the other hand, if the memory card 334 is not connected to the apparatus 30, the access path selection unit 306 may also determine if there is any external storage device 335 is connected to this apparatus 30 by the external access unit 309. The determination is also based on the electrical signals made by the external access unit 309. The external access unit 309 may be a set of circuitry including a specified connecting port and its control circuit for processing the signals sent over the connecting port. For example, USB and its controller may be adopted in the external access unit 309. In the current example, the control unit 301 may be electrically connected to the external storage device 335 through the access path selection unit 306 and the external access unit 309 in order to retrieve the device's information such as specification, capacity, and/or file system.

According to one of the embodiments of the present invention, the network apparatus 30 may include a computer system connecting unit 307 for connecting a computer system 333. The computer system connecting unit 307 may be a port for receiving electric power for the apparatus 30. For example, the legacy USB and its corresponding control circuit of the computer system 333 may form a charging interface. The computer system 333 may there-through supply power to the network apparatus 30. Further, the computer system 333 may thereby connect to network through the network apparatus 30, which conducts packet routing and forwarding, via USB.

The network apparatus 30 is preferably a device with an independent power supply. A power management unit 310 is installed for managing power allocation. The power management unit 310 governs the alternating current power 336 or direct current power 337 for the apparatus 30 while it determines if the alternating current power 336 or direct current power 337 is to be the main power. If there is built-in chargeable battery in the apparatus 30, the power management unit 310 may detect the battery power and direct the alternating current power to charge the battery.

The access path selection unit 306 may exemplarily be an intelligent circuit which itself is able to determine the access path. Further, the access path selection unit 306 may retrieve the signals from the control circuit (USB controller or control IC of memory card) over the access path. The process of conducting the access path selection may also be configurable to the access path selection unit 306.

In an exemplary example, the memory card access unit 308 may firstly determine whether or not any memory card 334 is plugged to the apparatus 30, and whether or not the memory card 334 is accessible successfully. If the memory card 334 has been connected according to the present example, the path to the memory card 334 is the major access path regardless of any other device is connected to the external access interface 309 until the memory card 334 is unplugged. While the memory card 334 is not connected to the apparatus 30, the access path selection unit 306 switches the access path to the external storage device 335 through the external access unit 309.

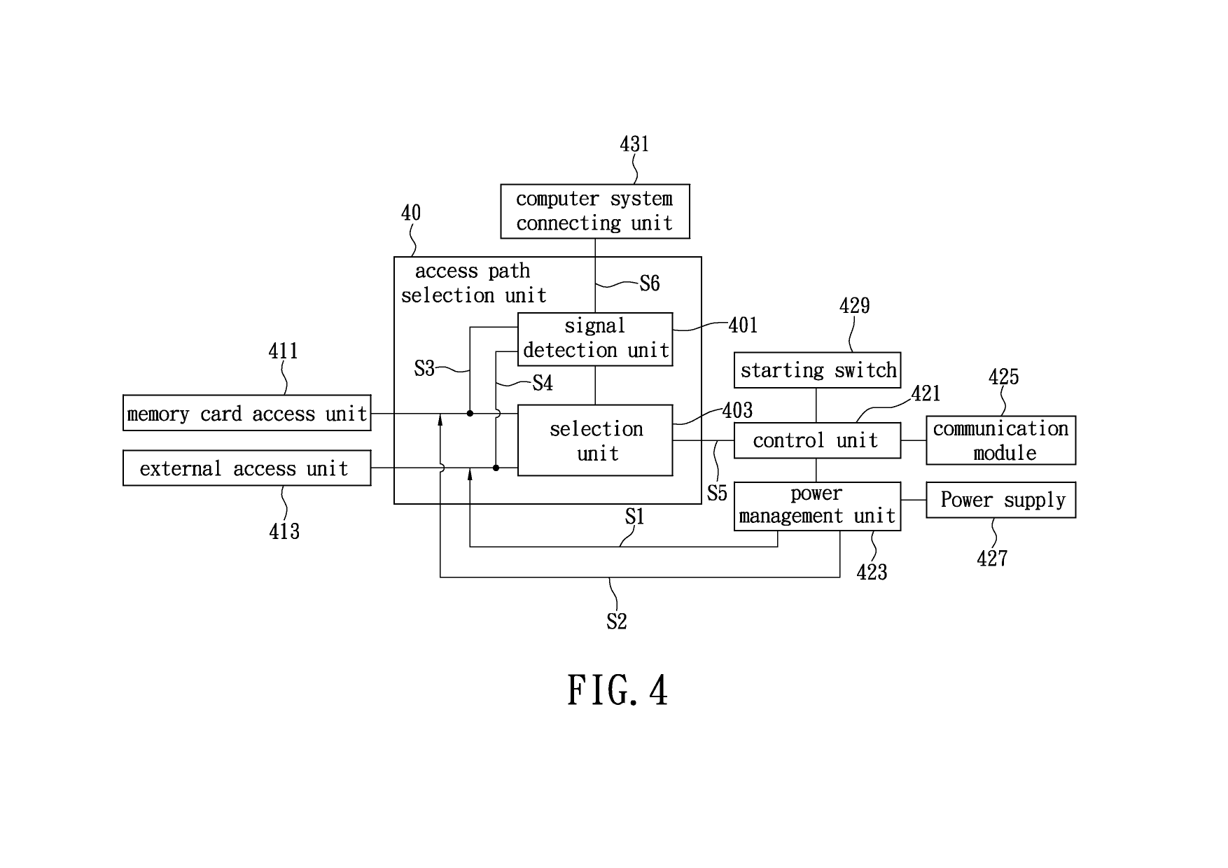

FIG. 4 schematically shows the design of the mechanism of access path selection made by the network apparatus according to one of the embodiments in the invention.

This diagram describes the connections of internal circuit components of the network apparatus. The apparatus provides at least two connecting members respectively connected to different external storage medium. Examples are referred to the shown two access units 411, 413.

Provision of a control unit 421 is the circuit kernel of the apparatus. The control unit 421 is in charge of processing the internal signals and delivering data therefor. The circuitry electrically connected to the control unit 421 includes communication module 425 for connecting with terminal devices. One of the objectives of the communication module 425 is to process the wire or wireless signals by the specific protocols. For a routing device, the communication module 425 is the circuit for processing the data packets. The control unit 421 and communication module 425 are the main circuits for conducting the packet routing. This communication module 425 may be used for handling the data packets forwarded among the different network segments.

A power management unit 423 electrically connected with the control unit 421 is also included. The power management unit 423 governs the electric power for operating the network apparatus and the inner components. The current example shows the power management unit 423 is electrically connected to at least two connecting members for external storage medium. The connecting members are such as the shown memory card access unit 411 and external access unit 413, and the signals S1 and S2 denote the powering connections respectively. The signals S1 and S2 directed to the connecting members also allow an access path selection unit 40 to acknowledge the connection status of any of the external storage medium. It is advantageous that the mechanism of the access path selection over the powering connections may achieve the purpose of power saving under the minimum power consumption. The power-saving scheme may be applied to both DC and AC power as follows.

The power management unit 423 is electrically connected with the control unit 421 and the mentioned at least two connecting members. The power management unit 423 also electrically connects to a power source 427 used to operate the apparatus. The power source may supply both direct current power and alternating current power. According to the supplied power, the power management unit 423 may conduct a selection of access path for allocating the internal power. Therefore, the one or more terminal devices may access one of the external storage medium according to one of the access paths selected by the access path selection unit 40.

According to one further embodiment, the network apparatus may include a starting switch 429 which is electrically connected to the control unit 421. This starting switch 429 allows the user to turn on or turn off the function of packet routing made by this network apparatus. This network apparatus may embody a routing device, and also a storage-shared apparatus. While the user presses the starting switch 429, the control unit 421 interprets a generated switching signal. The switching signal may be served to turn off the external network connection such as shutting down the wire connection. That means the terminal device or any computer system may still proximally access the memory card or external storage device connected with this apparatus even if the function of packets routing is shutdown.

In one exemplary embodiment of the access path selection unit 40 of the network apparatus, the network apparatus may retrieve information from the connected devices through this access path selection unit 40. It is noted that the related interface is such as USB for implementing the computer system connecting unit 431 (signal S6), the memory card access unit 411 pluggable to the memory card, and the external access unit 413 for connecting the external storage device.

A signal detection unit 401 is exemplarily installed in the access path selection unit 40. This signal detection unit 401 may be electrically connected to the computer system connecting unit 431, the memory card access unit 411, and the external access unit 413 for detecting the interfacing signals over those connections. The signal detection unit 401 may thereby determine if any device is connected according to the detection of electrical signals of the interfacing pins. For example, the signal detection unit 401 may confirm if any memory card is plugged to this network apparatus according to the signal S3 denoting the connection to the memory card access unit 411. Alternatively, the signal S4 over the connection to the access interface 413 is served to confirm the connection of any external device. The signal S6 over the connection to the computer system connecting unit 431 is also used to retrieve the relevant connection information.

The diagram shows that the control unit 421 may then retrieve the connection information from the access path selection unit 40 over the connections there-between. The control unit 421 provides the decision of the access path for the terminal device to access the external device through this network apparatus. The signal S5 denotes a selection signal operated by the control unit 421 to control the selection unit 403 to conduct the access path to the memory card access unit 411 or to the access interface 413.

In one embodiment of the present invention, the network apparatus provides at least two access interfaces for external storage medium. The access path is made by determining if any memory card plugged to this network apparatus. Under a normal operation of the network apparatus, the power management unit 423 may supply the minimum power consumption to the external control circuit. The shown signals S1 and S2 respectively denote the powering connections to the memory card access unit 411 and the external access interface 413.

According to one of the embodiments of present invention, the control unit 421 may acknowledge the connection signal S6 if the signal detection unit 401 detects an external computer system is connected to the apparatus through the computer system connecting unit 431. The computer system is such as the host capable of supplying power to the network apparatus or any other electronic device. In the meantime, the power management unit 423 of the apparatus may conduct the power supplied from the external host, and temporarily interrupt the powering connection from the internal battery. It is possible that battery can be charged by the power supplied from the host.

The network apparatus advantageously supplies a minimum power to the memory card access unit 411 for maintaining the lowest requirement of operation if the detection reveals there is no any memory card is plugged. On the contrary, the signal detection unit 401 may acknowledge the PIN signal S3 from the memory card access unit 411 if any memory card is plugged. The control unit 421 is accordingly controls the power management unit 423 to supply power to the memory card access unit 411 over the connection there-between (signal S2).

Still further, when there is no memory card plugged to the apparatus, the signal detection unit 401 determines whether or not any external device is connected according to the electrical signal (signal S4) of the pins associated with the external access unit 413. The external device is preferably a storage device according to the embodiment of the present invention. If the connected external device is confirmed, the control unit 421 acknowledges the status and initiates the power management unit 423 to power the interface over the connection S1. Otherwise, the apparatus may be operated under a minimum power consumption for the aim of power saving.

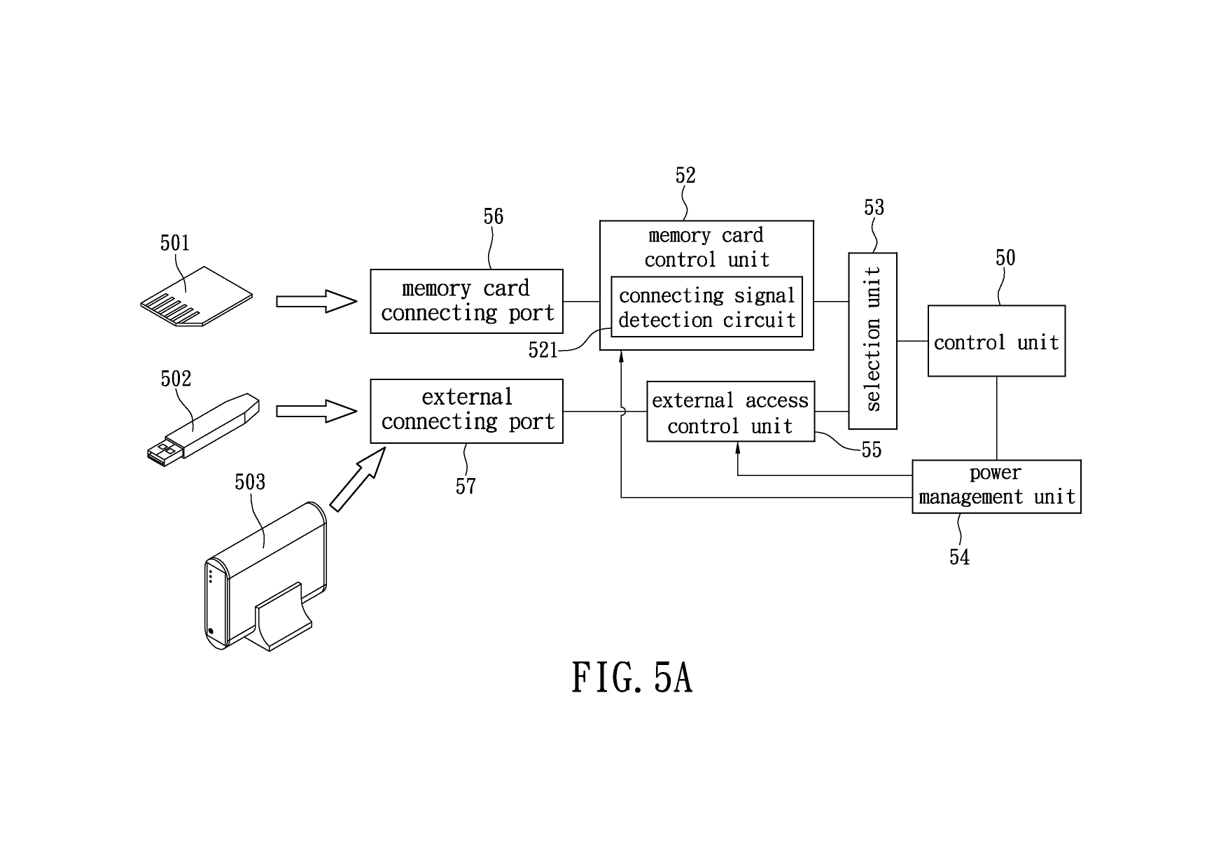

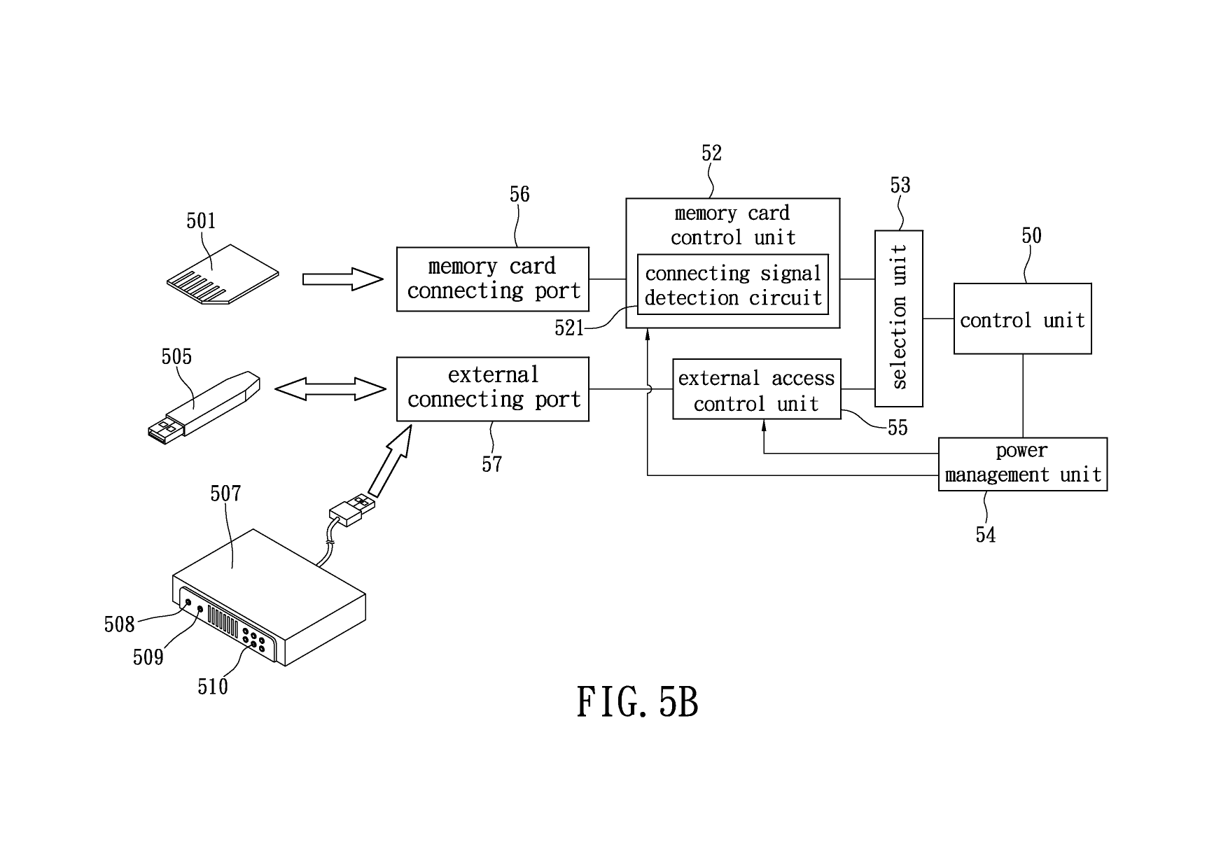

Reference is made to FIG. 5A, which describes schematic circuit in one further embodiment of the mechanism of access path selection made by the claimed network apparatus.

The network apparatus in accordance with the invention provides at least two connecting interfaces for at least two storage devices. The members of memory card control unit 52 and the memory card connecting port 56 constitute an access circuitry of memory card. Also, the external access control unit 55 and the external connecting port 57 embody an external access circuitry. For example, the memory card connecting port 56 is configured to accept a memory card 501 plugged to this network apparatus; and the external connecting port 57 is such as USB interface for establishing connection to one or more external storage devices. As shown in the diagram, the numerals 502 and 503 denote the connected external storage devices.

In an exemplary embodiment, the network apparatus may be configured to prioritize the determination of any connected memory card is connected. This prioritized determination affects the apparatus' arbitration of whether or not accessing the device over USB. The external connecting port 57 may indicate two or more connecting ports. The external access control unit 55 may govern the data transmittal among a plurality of connected external storage devices (502, 503) by way of a HUB-like mechanism. In general, HUB-like mechanism is for providing multiple Ethernet twisted pair wires or optical fibers and making them act under a single physical segment. When any external device, such as computer system, tablet computer, smartphone, or any other electronic device, desires to access the external storage devices (502, 503) through the claimed network apparatus, the external access control unit 55 acts as the HUB for providing multiple connections serving the one or more external devices. One of the connections may be conducted for each external device while the network apparatus is accessible over multiple connections.

In one further embodiment, the external access control unit 55 may be configured to connect with a wireless transceiver via the external connecting port 57, for example the USB. The wireless transceiver is such as the network card (dongle) in compliance with 3G/3.5G/4G wireless communication protocols. The wireless transceiver allows the network apparatus to function the mobile network connection. The network apparatus may therefore conduct data routing, and provide the connected device to surf the mobile network.

The memory card control unit 52, connected with the internal selection unit 53 and control unit 50, is in charge of processing the data of memory card 501 and serving the external access. The memory card control unit 52 may also integrate the circuit of the access path selection unit 40 described in FIG. 4. The shown memory card control unit 52 includes a connecting signal detection circuit 521, which directly detects the status of a specific pin of the memory card connecting port 56. The memory card control unit 52 therefore acknowledges the information of any memory card 501 is plugged to the connecting port 56.

After that, the control unit 50 may successfully acquires the connection information of any external device. A control signal is therefore generated to initiate the power management unit 54 to process power allocation of the memory card control unit 52 and the external access control unit 55. If the plugged memory card 501 is detected, the detection signal is forwarded to the control unit 50. The power management unit 54 is then configured to power the memory card control unit 52 no matter whether or not any external storage device 502 is existed. The apparatus may supple a minimum power to the external access control unit 55 under the circumstances. On the contrary, the power management unit 54 supplies full power to the external access control unit 55 for accessing the connected external storage device 502 while there is no connected memory card 501. Similarly, the memory card control unit 52 receives a minimum power supply. The selection unit 53 is configured to dominate the control unit 50 to configure the access path for the external terminal device if the plugged memory card 501 or connected external storage device 502 is confirmed. The above-described mechanism aims the goal of power saving.

Rather than the above-described determination of if memory card 501 is plugged to the apparatus makes the decision of power allocation, the situation of the external storage device 502 may also be the main consideration of allocating the power.

In one further embodiment, rather than the independent power supply adopted by the network apparatus, the network apparatus with function of access path selection may be integrated into a power adapter for the terminal device such as the tablet computer, smartphone or any other electronic device. The integration may reduce cost of use of wires and also increase portability because it allows the network apparatus to use the power adapter together with the terminal device connected to the apparatus.

FIG. 5B schematically shows the circuit implementing one of the functions of the apparatus in accordance with the present invention.

The mentioned external access control unit 55 of the network apparatus is provided to connect with an external audio-video processing unit. This audio-video processing unit allows the network apparatus to deliver the audio-video signals.

The legacy USB carries out the external access control unit 55, by which an external audio signal processing device 505 may be allowed to connect with the external access control unit 55. By this audio signal processing device 505, the network apparatus is able to process the output or input audio signals. Further, an audio-video processing unit 507 including a microphone jack 508, a loudspeaker jack 509, and an audio-video port 510 may be connected to the apparatus. The network apparatus is able to route the audio-video signals since the audio-video processing unit 507 is capable of processing digital-analog conversion.

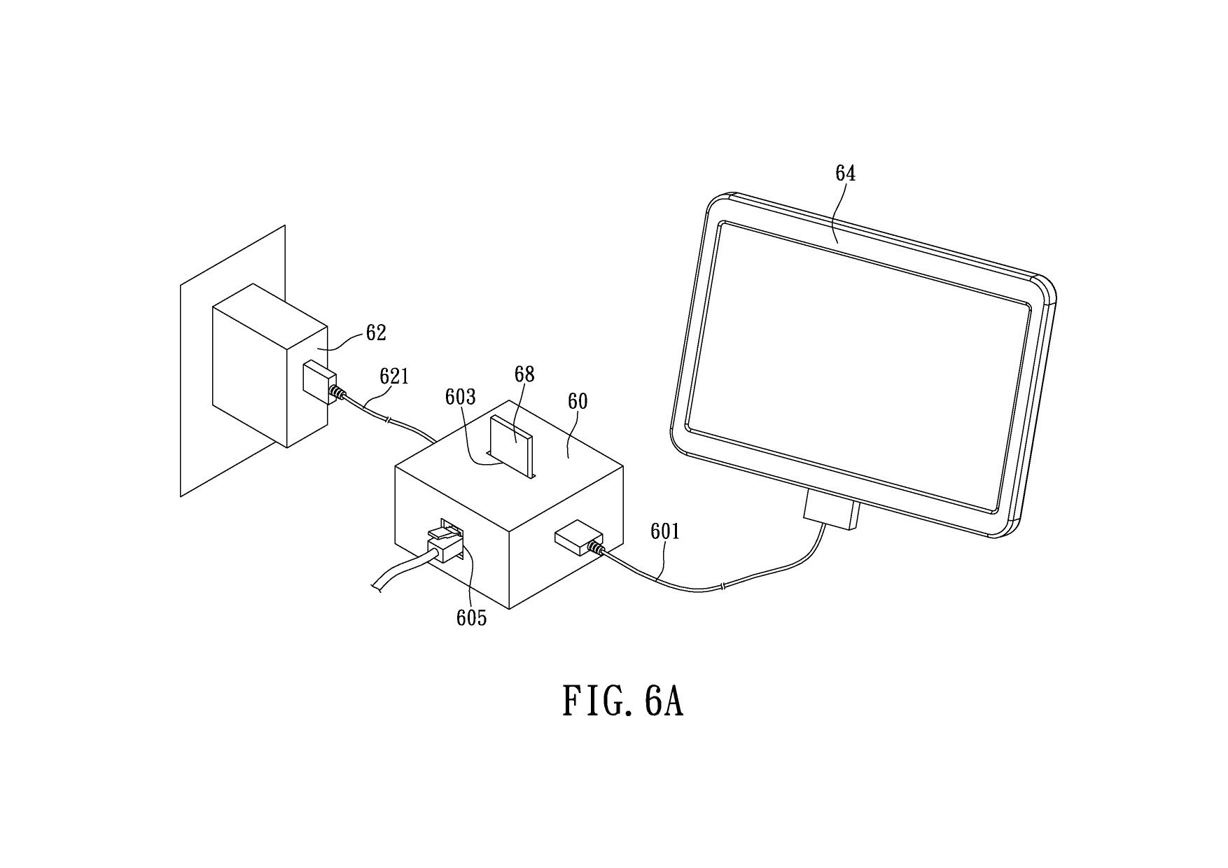

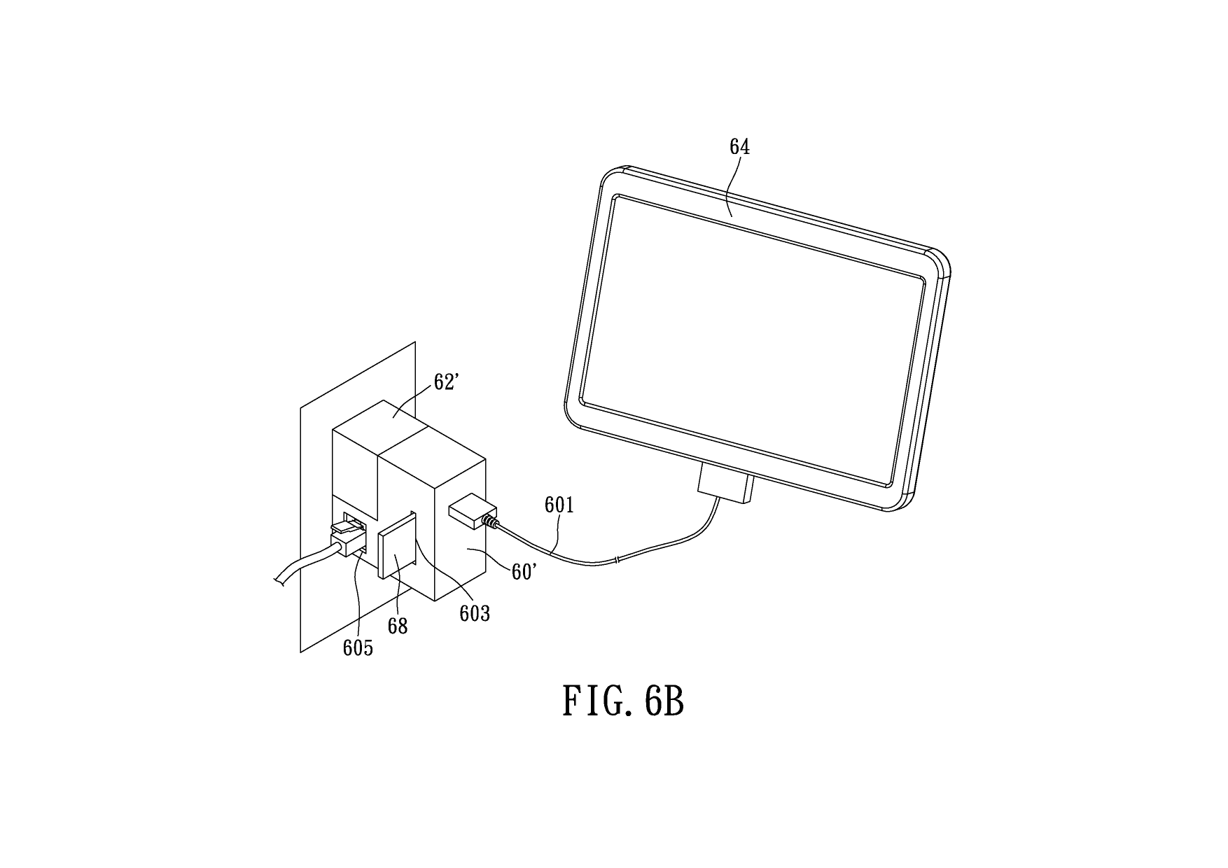

Reference is made to FIG. 6A schematically describing the embodiment of power connection for the network apparatus.

A network apparatus 60 in this disclosure provides service of remote access for the terminal device 64 to access a memory card 68 which is plugged to this apparatus 60. The network apparatus 60 includes not only a memory card slot 603 for the remote access, but also a connecting port 605 for the terminal device 64 to establish connection to the other network segment. Therefore, the terminal device 64 may simultaneously access the memory card 68 of the apparatus 60 and link to network thereby.

Furthermore, the network apparatus 60 also serves power transferring for the terminal device 64 which is connected to this apparatus 60. The network apparatus 60 is electrically connected with a power adapter 62 over a power line 621 for retrieving power. The network apparatus 60 uses its other end to link with the terminal device 64 via a connecting port and a power line 601. The power-transferring circuit (not shown) in the network apparatus 60 may successively connect the power adapter 62 with and supply power to the terminal device 64.

Exemplarily, USB is regularly adopted by the electronic device to connect with a power source and the shown power adapter 62 may be installed with a USB port. The present embodiment shows the network apparatus 60 may take power through this USB port. This network apparatus 60 also has one more USB port for transferring power to external. Therefore the terminal device 64 may commonly connect with the same power adapter 62 with the apparatus 60. In other words, the power adapter 62 supplies power to both the network apparatus 60 and the terminal device 64. Simultaneously, the internal battery of the apparatus 60 can be charged by this powering scheme.

FIG. 6B schematically shows one further embodiment of the network apparatus connected with another power source.

The network apparatus 60′ embodies an auxiliary device directly connected with the power adapter 62′. That means, the network apparatus 60′ is connected to an electric outlet of the power adapter 62′, and the outlet is preferably the USB. The network apparatus 60′ in accordance with the present embodiment may relay the power output from the power adapter 62′ to powering the terminal device 64 over the power line 601.

The network apparatus 60′ is connected to the terminal device 64 over the power line 601. For example, the apparatus 60′ may supply power to or electrically charge the terminal device 64. By this design, the network apparatus 60′ may be an auxiliary device electrically connected with the power adapter 62′. By which, the terminal device 64 can be powered from the apparatus 60′. The network apparatus 60′ further provides wireless network connection for the terminal device 64. The apparatus 60′ also provides a memory card slot 603 pluggable to the memory card 68, or a connecting port specified to an external storage device. A connecting port 605 is also provided for packet routing wired to the external network.

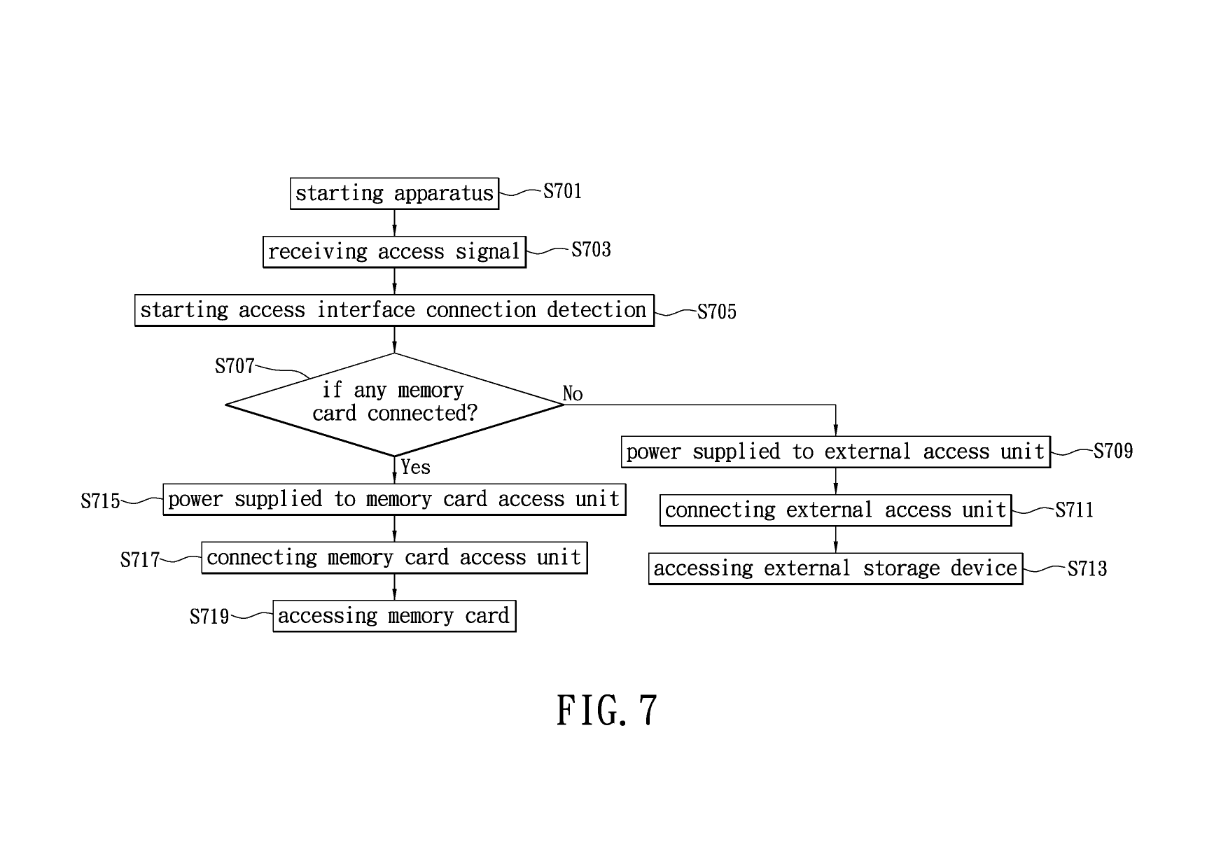

In brief, the present invention is featured that a service to access at least two external storage medium is provided in the claimed network apparatus. The feature allows a function of access path selection in the apparatus. FIG. 7 shows a flow chart illustrating steps of selecting the access path.

In the beginning of the process, such as step S701, the network apparatus is initiated. The power management, network communication, and the external connecting ports are ready to be operated. The network apparatus then listens to the connection request from each connected terminal device. The terminal device may require accessing the external storage medium which is connected to this network apparatus in addition to the regular routing task. The network apparatus is activated to detect any connection signal from the access interfaces (step S705) while the apparatus receives the access request (step S703).

According to one of the embodiments of the network apparatus, an internal signal detection unit is used to conduct the detection of if any electronic pin signal indicative of any memory card is plugged to the network apparatus (step S707). Preferably, the detection is applied to detect the connecting signal associated with a specific pin of the memory card. Once any memory card is connected to the card-reading interface of the network apparatus, the mentioned memory card control unit will receive a connecting signal. The internal signal detection unit may continuously monitor this connecting signal. The control unit of the apparatus accordingly generates a control signal for conducting the access path selection. The selection is applied to the access path to memory card access unit for the memory card, or the access path to the external access unit for the external storage device.

In practice, when the detection of the connection to a memory card reveals negative (No), it shows there is no any memory card is plugged to the network apparatus. In the meantime, if any external storage device is connected to this apparatus over the other one access interface. Such as step S709, the control unit controls power allocated to the external access unit in association with the external storage device. On the other hand, for purpose of power-saving, the power may be supplied to the memory card access unit with a minimum requirement of power consumption. The control unit, meanwhile, is configured to switch the access path to the external access unit by a selection unit (step S711). The terminal device is therefore accessing the external storage device (step S713).

The determination “yes” reveals the memory card is plugged to an access interface, as the step S715 describes. The control unit accordingly controls the power supplied to the memory card access unit, and switches the access path to the memory card access unit by a selection circuit (step S717). Therefore, the terminal device announcing the access request is allowed to access the memory card directly (step S719).

In summation of the above description, the network apparatus capable of performing the access path selection may be simultaneously equipped with two or more interfaces for connecting the external storage medium. File system of the network apparatus is configured to resolve the access signals. The network apparatus provides remote access service for the connected terminal device by wire or wireless communication. That means the apparatus provides a solution for the device lacking of storage expansion to conduct the remote access. Furthermore, the network apparatus has integrated with the functions of the simplified network attached storage (NAS) and card reader. Through the power management, the apparatus also achieve intelligent energy and card hot swapping.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A network apparatus with function of access path selection, comprising:
a control unit for conducting signals and data processing within the network apparatus;
a communication module, electrically connected to the control unit, for processing wire or wireless communication protocol within the network apparatus;
at least two connecting members for connecting with at least two external storage medium;
an access path selection unit, electrically connected to the control unit and the at least two connecting members, for selecting an access path according to electrical signal made by one of the at least two connecting members; and
a power management unit, electrically connected to the control unit and at least two connecting members, for allocating power according to connection status of the at least two external storage medium from the access path selection unit.

2. The network apparatus according to claim 1, wherein the at least two connecting members of the external storage medium include:
a memory card access unit provided for plugging a memory card; and
an external access unit provided for connecting with an external storage device.

3. The network apparatus according to claim 2, wherein the memory card access unit includes a memory card connecting port provided for plugging the memory card and a memory card control unit; the external access unit includes a connecting port provided for connecting with the external storage device and an external access control unit.

4. The network apparatus according to claim 3, wherein the memory card control unit includes a connecting signal detection circuit for integrating the access path selection unit.

5. The network apparatus according to claim 3, wherein the external connecting port is a universal serial bus.

6. The network apparatus according to claim 5, wherein the external connecting port is a hub having a plurality of universal serial buses.

7. The network apparatus according to claim 2, wherein the access path selection unit includes a signal detection unit, which is for detecting electrical signal of the memory card access unit or the external access unit.

8. The network apparatus according to claim 1, wherein the network apparatus is a network routing device provided for establishing connection and processing packet routing of one or more terminal devices; the control unit and the communication module are the main circuit for processing the packet routing, and the communication module is used to forward the data packets of connections over different network domains.

9. The network apparatus according to claim 8, further comprising a starting switch, electrically connected to the control unit, provided for turning on or off the function of packet routing of the network apparatus.

10. The network apparatus according to claim 1, wherein the network apparatus includes a computer system connecting unit for connecting to an external computer system.

11. A method for selecting access path of the network apparatus according to claim 1, comprising:
the network apparatus activated to detect a connection signal from any of the connecting members including a memory card access unit and an external access unit when the apparatus receives an access request, wherein the memory card access unit is provided for plugging a memory card and the external access unit is provided for connecting with an external storage device.
if it is detected that the memory card is plugged to the network apparatus while a memory card control unit receives a connecting signal, the control unit of the network apparatus generates a control signal for selecting the access path to the memory card access unit for a terminal device accessing the memory card; and
if it is detected that the external storage device is connected to the network apparatus while an external access control unit receives the connecting signal, the control unit generates the control signal for selecting the access path to the external access unit for the terminal device accessing the external storage device.

12. The method according to claim 11, wherein the detection is applied to detect the connecting signal associated with a specific pin of the memory card.

13. The method according to claim 12, wherein the network apparatus includes an internal signal detection unit which is used to conduct the detection of an electronic pin signal indicative of the memory card is plugged to the network apparatus.

14. The method according to claim 11, wherein when the memory card is detected to connect with the network apparatus, the power is supplied to the memory card access unit with a minimum requirement of power consumption.

15. The method according to claim 11, wherein when the external storage device is detected to connect with the network apparatus, the power is supplied to the external access unit with a minimum requirement of power consumption.
